(19) United States
(12) Patent Application Publication
(10) Pub. No.: US 2015/0089491 A1
(43) Pub. Date: Mar. 26, 2015

(54) SOFTWARE INSTALLATION METHOD, TERMINAL, AND COMPUTER STORAGE MEDIUM

(71) Applicant: TENCENT TECHNOLOGY (SHENZHEN) COMPANY LIMITED, Shenzhen (CN)

(72) Inventors: Qing Wang, Shenzhen (CN); Haoran Guo, Shenzhen (CN); Quanhao Xiao, Shenzhen (CN); Yixia Yuan, Shenzhen (CN); Xunchang Zhan, Shenzhen (CN); Chunyou Lin, Shenzhen (CN); Pengtao Li, Shenzhen (CN); Jiashun Song, Shenzhen (CN)

(21) Appl. No.: 14/559,750

(22) Filed: Dec. 3, 2014

Related U.S. Application Data
(63) Continuation of application No. PCT/CN2013/076781, filed on Jun. 5, 2013.

(30) Foreign Application Priority Data
Jun. 7, 2012 (CN) 201210185798.2

(51) Int. Cl. G06F 9/445; H04L 29/08; G06F 3/0481; G06F 9/44

(52) U.S. Cl. CPC G06F 8/61; G06F 9/4446; H04L 67/10; G06F 3/04817
USPC 717/175

(57) ABSTRACT

A software installation method is provided by the present disclosure. According to the software installation method, a simplified installation request for software is received; a first installation package which only contains a basic function of the software is downloaded, the software including the first installation package and at least one second installation package which can be installed selectively and contains an additional function or additional functions expanded from a basic function of the software; and the first installation package is analyzed to install the basic function. Meanwhile, a terminal, and a corresponding computer storage medium are provided. With the technical solutions of the present disclosure, network traffic and storage space can be saved.

### CROSS REFERENCE TO RELATED APPLICATIONS

The present application is a continuation application of PCT Patent Application No. PCT/CN2013/076781, entitled “Software Installation Method, Terminal, System, and Computer Storage Medium”, filed Jun. 5, 2013, which claims the benefit and priority to Chinese Patent Application No.201210185798.2, entitled “Software Installation Method, Terminal, and System”, filed Jun. 7, 2012, both of which are incorporated herein in their entirety by reference.

### TECHNICAL FIELD

The present disclosure relates to terminal technologies, and especially to a software installation method, terminal, and computer storage medium.

### BACKGROUND

Presently, software has more and more functions, that is, besides of a basic function, software also having a lot of additional functions; and the size of software installation packages becomes larger and larger accordingly.

Generally, for a piece of software, a user may only use a part of its functions, for example, using its basic function, or may use one or several additional functions besides of the basic function.

However, according to traditional processing methods, if a user intends to install software on his terminal, he needs to download a full installation package of the software from a server, and accordingly, after the installation package is downloaded and installed, the installed software will have a basic function and all additional functions at the same time. As described in the foregoing, some of the additional functions may not be necessary for the user, and thus when these unnecessary additional functions are present, network traffic cost during download of them will be increased, and storage space occupied by the software after it is installed will be increased too.

### SUMMARY

In view of this, the present disclosure provides a software installation method, terminal, system, and computer storage medium, in this way network traffic and storage space can be saved.

The technical solutions of the present disclosure are as follows.

In an aspect, a software installation method is provided, which includes:
receiving a simplified installation request for software;
downloading a first installation package which only contains a basic function of the software, the software including the first installation package and at least one second installation package which is to be installed selectively and contains an additional function expanded from the basic function of the software; and
analyzing the first installation package to install the basic function of the software.

In a further aspect, a terminal is provided. The terminal includes a memory and a processor which communicates with the memory, in which on the memory, a first receiving instruction, a first downloading instruction, and a first analytic instruction executable by the processor are stored, and in which
the first receiving instruction is configured to instruct receiving a simplified installation request for software;
the first downloading instruction is configured to instruct downloading a first installation package which contains a basic function of the software after the simplified installation request for the software is received according to the first receiving instruction; the software including the first installation package and at least one second installation package which is to be installed selectively and contains an additional function expanded from the basic function of the software; and
the first analytic instruction is configured to instruct analyzing the first installation package to install the basic function of the software.

In an aspect, a computer storage medium is provided, on which a computer program configured to execute the above method is stored.

With the technical solutions of the present disclosure, for any software, a user may only download a first installation package which corresponds to its basic function, and accordingly, the software after the installation will only has the basic function. If the user wants to use a certain additional function or several additional functions of the software subsequently, he may download a second installation package or second installation packages corresponding to the certain additional function or the several additional functions respectively, so as to add the additional function(s) he needs to the installed software.

Compared to the traditionally directly downloading a full installation package and then install it, when the solution of the present disclosure is used, since the amount of data which needs to be downloaded is reduced, thus network traffic cost during the downloading is saved, and further the storage space occupied by the installed software is reduced accordingly.

### BRIEF DESCRIPTION OF THE DRAWINGS

FIG. 1 is a schematic diagram illustrating a flowchart of a software installation method provided according to an embodiment of the present disclosure;

FIG. 2 is a schematic diagram illustrating a guide interface according to an embodiment of the present disclosure;

FIG. 3 is a schematic diagram illustrating a function had by installed software at an initial stage according to an embodiment of the present disclosure;

FIG. 4 is a schematic diagram illustrating functions had by the installed software after additional function F1 is added according to an embodiment of the present disclosure;

FIG. 5 is a schematic diagram illustrating functions had by the installed software after additional function F3 is added according to an embodiment of the present disclosure;

FIG. 6 is a schematic diagram illustrating a structure of a software installation system provided according to an embodiment of the present disclosure; and

FIG. 7 is a schematic diagram illustrating a structure of a software installation terminal provided according to an embodiment of the present disclosure.

### DETAILED DESCRIPTION

The present disclosure provides a software installation method. According to the software installation method, a simplified installation request for software is received; a first installation package which only contains a basic function of the software is downloaded, the software including the first installation package and at least one second installation package which can be installed selectively and contains an additional function or additional functions expanded from the basic function of the software; and the first installation package is analyzed to install the basic function. Further, according to the method, a request for installing a second installation package is received, the second installation package is downloaded, and the second installation package is analyzed to install an additional function.

FIG. 1 is a schematic diagram illustrating a flowchart of a software installation method provided according to an embodiment of the present disclosure. As shown in FIG. 1, the method includes the following blocks.

At block 11, a simplified installation request for software is received.

Software is a set of computer data and requests organized according to a certain sequence. Generally, software may include system software, application software, middleware between the system software and the application software, etc.

When a user needs to install certain software, he may select a simplified installation or a full installation according to his requirement.

The simplified installation means that software after an installation thereof only has a basic function, and the full installation means that software after an installation thereof has both a basic function and all additional functions.

In practice, when the user needs to install software, he may first enter into a related webpage of a certain website which provides download of installation packages of the software. On the webpage, two buttons for the software, a simplified installation button and a full installation button, may be shown at the same time. If the user clicks on the simplified installation button, this indicates that the user sends out a simplified installation request, and if the user clicks on the full installation button, this indicates that the user sends out a full installation request. If the terminal determines that the user sends out the full installation request, then the terminal will download a full installation package of the software, and analyze and install the full installation package after the download of it is completed. In the above block 11, it is deemed that the user clicks on the simplified installation button.

Setting the full installation button is to consider that some users may need to use all functions of the software, or even if some users may not need to use all the functions of the software, he may still want the installed software to have all the functions. The full installation button is to meet the requirement of this kind of users.

At block 12, a first installation package which only contains the basic function of the software is downloaded, the software including the first installation package and at least one second installation package which can be installed selectively and contains an additional function or additional functions expanded from the basic function of the software.

Since at block 11, the terminal determines that the user sends out the simplified installation request, then at block 12, the terminal downloads the first installation package corresponding to the basic function of the software.

The first installation package corresponding to the basic function of the software and the second installation package(s) corresponding to the respective additional function(s) constitute the full installation package of the software.

At block 13, the first installation package is analyzed to install the basic function.

After the first installation package containing the basic function of the software is downloaded at block 12, at block 13, the first installation package is analyzed and installed.

Subsequently, if an installation request of a second installation package is received, the second installation package is downloaded; and the second installation package is analyzed to install an additional function.

As described in the foregoing, since at block 11, the terminal determines that the user sends out the simplified installation request, then at block 12, the terminal downloads the first installation package corresponding to the basic function of the software, and then after the download is completed, at block 12, the terminal analyzes and installs the download first installation package. In this case, installed software has only the basic function, and if necessary, the user may add additional functions to the installed software.

For the installed software, on an operation interface of it, an additional function installation button may be shown. When the user clicks on the button, which indicates that a request for installing an additional function is sent out, the terminal may show a guidance interface to the user to guide the user to selectively install the second installation package. There is at least one second installation package.

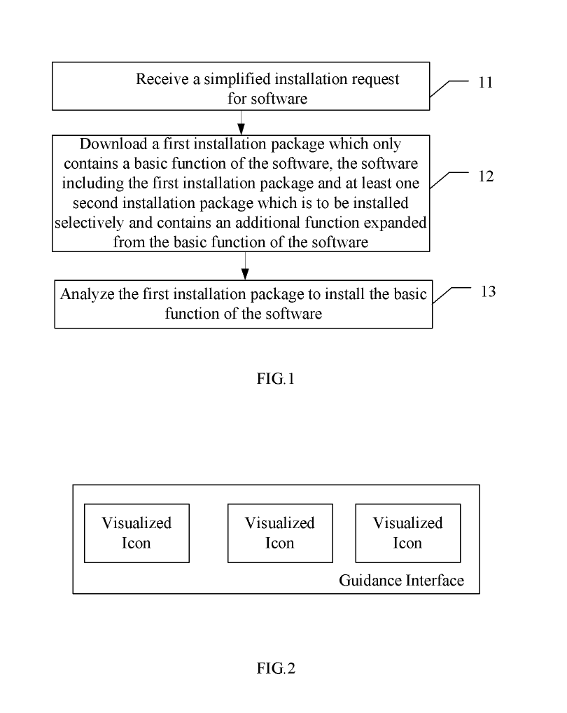

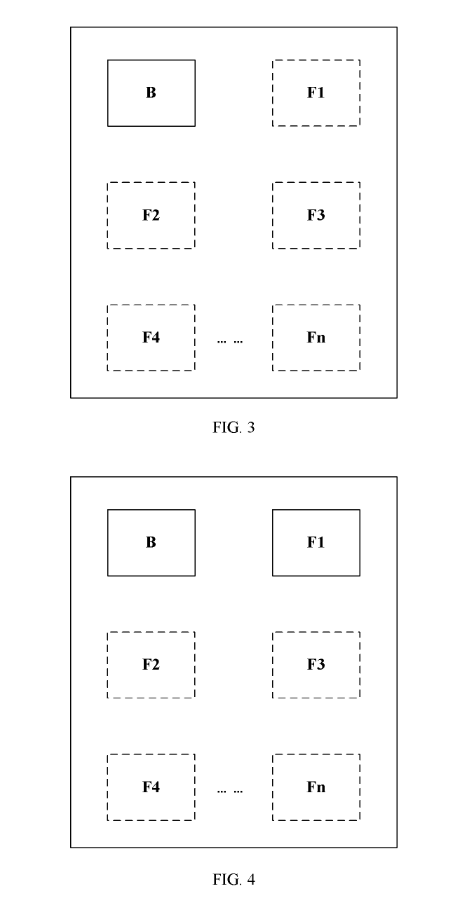

As shown in FIG. 2, assuming that there are 3 second installation packages, then on the guidance interface shown in FIGS. 2, 3 visualized icons are shown, and each visualized icon corresponds to an additional function, i.e., corresponding to a second installation package. When it is monitored that the user clicks on a visualized icon, then it is deemed that the user sends out an installation request dedicated for a second installation package corresponding to the visualized icon. Accordingly, the second installation package is downloaded, and after the second installation package is downloaded, it is analyzed and installed, so that the additional function corresponding to the second installation package is added to the installed software.

In practice, when the terminal needs to download the first installation package or the second installation package of the software, an identity of the first installation package or the second installation package may be sent to a server, i.e., a server corresponding to the website which provides download of the software mentioned above. The server may store respective installation packages of the software and identities corresponding to them respectively, and when the server receives an identity sent from the terminal, an installation package corresponding to the identity is downloaded to the terminal.

In addition, an identity is set for the full installation package of the software. If the terminal determines that the user sends out the full installation request, then it sends the identity of the full installation package of the software to the server.

It is to be specified that if the user needs only to use the basic function of the software, then the subsequent second installation package will not be downloaded and installed.

The method of the present disclosure may be implemented by a dynamic link library (DLL). The DDL is a library containing codes and data that can be used by multiple programs at the same time. The DDL is very favorable for software programming and updating. During programming, a large software project may be separated into multiple individual modules. In these modules, invoking relations between them are defined, and then these modules may be written by multiple programmers respectively. An installation package in the method of the present disclosure may correspond to a module.

The process shown in FIG. 1 may be illustrated as follows.

Assume that the software has basic function B and addition functions F1, F2, F3, F4, . . . , and Fn.

As shown in FIG. 3, during installation, according to the simplified installation request received from the user, the terminal downloads a first installation package corresponding to the basic function B from the server, and installs the first installation package after the download of it is completed. In this way, the software only has the basic function B as shown by the solid-line block in FIG. 3, and has no additional functions F1, F2, F3, F4, . . . , and Fn as shown by the dashed-line blocks in FIG. 3.

As shown in FIG. 4, if the terminal receives an installation request for the additional function F1 sent from the user, then it downloads a second installation package corresponding to the additional function F1 from the server, and installs the second installation package after it is downloaded. In this way, the installed software has the basic function B and the additional function F1.

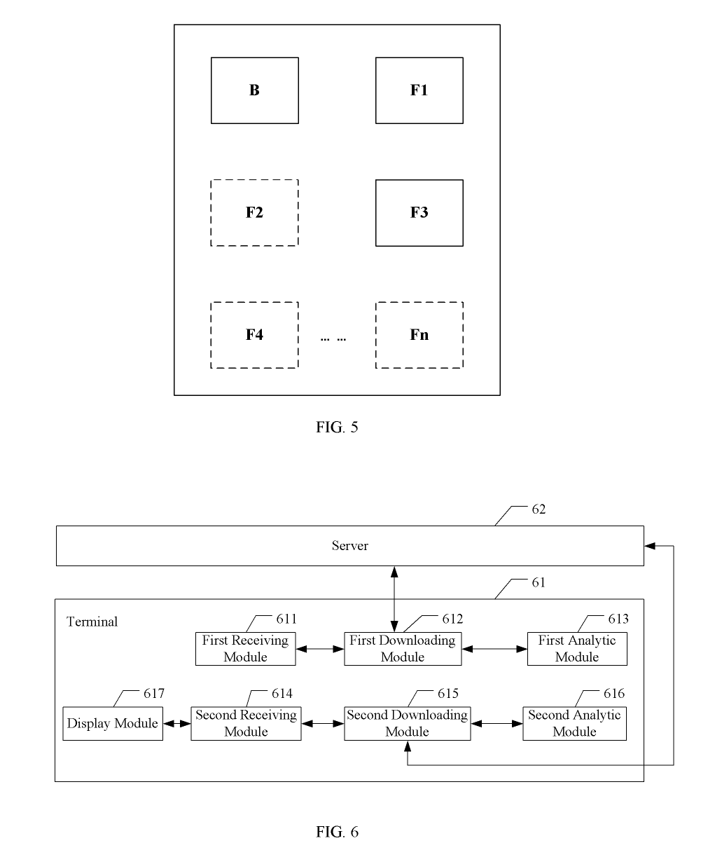

As shown in FIG. 5, it can be understood that if the terminal receives an installation request for the additional function F3 sent from the user, then it downloads a second installation package corresponding to the additional function F3 from the server, and installs the second installation package after it is downloaded. In this way, the installed software has the basic function B and the additional functions F1 and F3. Other possible situations will not be elaborated one by one herein.

Based on the above description, FIG. 6 is a schematic diagram illustrating a structure of a software installation system provided according to an embodiment of the present disclosure. As shown in FIG. 6, the software installation system includes a terminal 61 and a server 62.

The terminal 61 is configured to receive a simplified installation request of software; download a first installation package which only contains a basic function of the software from the server 62, the software including the first installation package and at least one second installation package which can be installed selectively and contains an additional function or additional functions expanded from the basic function of the software; and analyze the first installation package to install the basic function.

The server 62 is configured to provide download of respective installation packages for the terminal 61.

The terminal 61 is further configured to receive an installation request for a second installation package; download the second installation package from the server 62; and analyze the second installation package to install an additional function.

The terminal 61 is further configured to display a guidance interface to guide the user to selectively install the at least one second installation package, and for a second installation package, display a corresponding visualized icon on the guidance interface.

The terminal 61 may include:
a first receiving module 611 configured to receive a simplified installation request of software and notify it to a first downloading module 612;
the first downloading module 612 configured to download a first installation package which only contains a basic function of the software, and send it to a first analytic module 613; the software including the first installation package and at least one second installation package which can be installed selectively and contains an additional function or additional functions expanded from the basic function of the software; and
the first analytic module 613 configured to analyze the first installation package to install the basic function of the software.

In addition, the terminal 61 may further include:
a second receiving module 614 configured to receive an installation request for a second installation package, and notify it to a second downloading module 615;
the second downloading module 615 configured to download the second installation package, and send it to a second analytic module 616; and
the second analytic module 616 configured to analyze the second installation package to install an additional function corresponding to the second installation package.

The terminal 61 may further include:
a display module 617 configured to display a guidance interface to guide a user to selectively install the at least one second installation package, and for a second installation package, display a corresponding visualized icon on the guidance interface.

In practice, the second receiving module 614 may determine whether it receives an installation request for a second installation package by monitoring whether the user clicks on a visualized icon on the guidance interface.

For detailed workflow of the system shown in Fig.6, please refer to the corresponding description in the forgoing method embodiment, which will not be elaborated herein.

A machine readable storage medium is provided according to an embodiment of the present disclosure, configured to store instructions which when executed causes the machine to execute the software installation method described herein. A system or a device has the machine readable storage medium may be provided, and on the storage medium, software program codes which carry out the functions in any of the embodiments are stored, and a computer (or a CPU or a MPU) of the system or the device may read out and execute the software program codes stored on the storage medium.

In this case, the program codes per se read out from the storage medium may realize the functions in any of the foregoing embodiments, and thus the program codes and the storage medium which stores the program codes constitute a part of the present disclosure.

The storage medium which provides the program codes according to the present embodiment may be a floppy disk, a hard disk, a magnetic disk, a magneto-optical disk, an optical disk (e.g., a CD-ROM, a CD-R, a CD-RW, a DVD-ROM, a DVD-RAM, a DVD-RW, or a DVD+RW), a magnetic tape, a non-volatile storage card, or a ROM. As an option, the program codes may be downloaded from a server computer through a communication network.

It is to be aware that an operating system on the computer may carry out a part of or all of the actual operations by executing program codes read out by a computer, or by executing program code-based instructions, so as to realize the functions in any of the foregoing embodiments.

It is to be understood that by writing the program codes read out from the storage medium into a memory set on an extension board plugged into a computer or writing them into a memory set on an extension unit connected with the computer, and then causing a CPU installed on the extension board or on the extension unit to execute all of or a part of actual operations based on the instructions of the program codes, the functions in any of the foregoing embodiments may be realized.

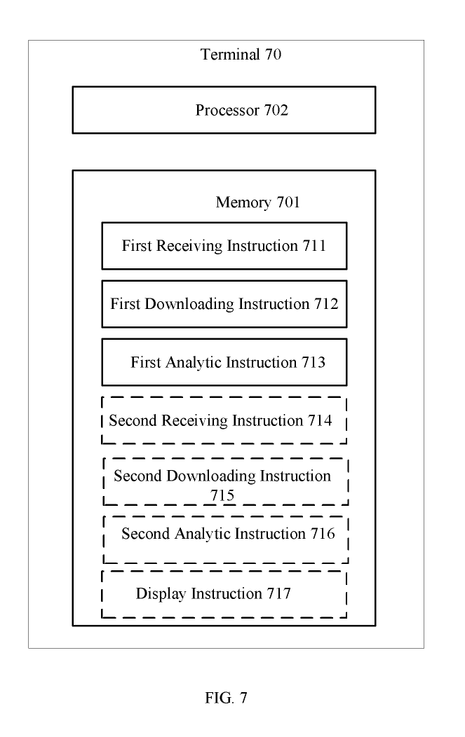

For example, FIG. 7 is a schematic diagram illustrating a structure of a software installation terminal 70 provided according to an embodiment of the present disclosure. The terminal 70 includes a memory 701 and a processor 702 which communicates with the memory 701. On the memory 701, a first receiving instruction 711, a first downloading instruction 712, and a first analytic instruction 713 executable by the processor 702 are stored.

The first receiving instruction 711 is configured to instruct receiving a simplified installation request for software.

The first downloading instruction 712 is configured to instruct downloading a first installation package which only contains a basic function of the software after the simplified installation request for the software is received according to the first receiving instruction 711. The software includes the first installation package and at least one second installation package which can be installed selectively and contains an additional function or additional functions expanded from the basic function of the software.

The first analytic instruction 713 is configured to instruct analyzing the first installation package to install the basic function of the software.

In addition, on the memory 701, a second receiving instruction 714, a second downloading instruction 715, a second analytic instruction 716, and a display instruction 717 executable by the processor 702 may be further stored.

The second receiving instruction 714 is configured to instruct receiving an installation request for a second installation package.

The second downloading instruction 715 is configured to instruct downloading the second installation package after the installation request for the second installation package is received according to the second receiving instruction 714.

The second analytic instruction 716 is configured to instruct analyzing the second installation package to install an additional function corresponding to the second installation package.

The display instruction 717 is configured to instruct displaying a guidance interface to guide a user to selectively install the at least one second installation package, and for a second installation package, displaying a corresponding visualized icon on the guidance interface.

In practice, whether an installation request for a second installation package is received can be determined by monitoring whether the user clicks on a visualized icon on the guidance interface.

With the technical solutions of the present disclosure, for any software, a user may only download a first installation package which corresponds to its basic function, and accordingly, the software after the installation will only has the basic function. If the user wants to use a certain additional function or several additional functions of the software subsequently, he may download a second installation package or second installation packages corresponding to the certain additional function or the several additional functions respectively, so as to add the additional function(s) he needs to the installed software.

Compared to the traditionally directly downloading a full installation package and then install it, when the solution of the present disclosure is used, since the amount of data which needs to be downloaded is reduced, thus network traffic cost during the downloading is saved, and further the storage space occupied by the installed software is reduced accordingly.

What is claimed is:

1. A software installation method, comprising:
receiving a simplified installation request for software;
downloading a first installation package which contains a basic function of the software, the software including the first installation package and at least one second installation package which is to be installed selectively and contains an additional function expanded from the basic function of the software; and
analyzing the first installation package to install the basic function of the software.

2. The method of claim 1, wherein the method further comprises:
receiving an installation request for a second installation package;
downloading the second installation package; and
analyzing the second installation package to install an additional function corresponding to the second installation package.

3. The method of claim 1, wherein the method further comprises:
displaying a guidance interface to guide a user to selectively install the at least one second installation package, and for a second installation package, displaying a corresponding visualized icon on the guidance interface.

4. The method of claim 2, wherein the method further comprises:
displaying a guidance interface to guide a user to selectively install the at least one second installation package, and for a second installation package, displaying a corresponding visualized icon on the guidance interface.

5. A terminal, comprising a memory and a processor which communicates with the memory, wherein on the memory, a first receiving instruction, a first downloading instruction, and a first analytic instruction executable by the processor are stored, and wherein
the first receiving instruction is configured to instruct receiving a simplified installation request for software;
the first downloading instruction is configured to instruct downloading a first installation package which contains a basic function of the software after the simplified installation request for the software is received according to the first receiving instruction; the software including the first installation package and at least one second installation package which is to be installed selectively and contains an additional function expanded from the basic function of the software; and
the first analytic instruction is configured to instruct analyzing the first installation package to install the basic function of the software.

6. The terminal of claim 5, wherein on the memory, a second receiving instruction, a second downloading instruction, and a second analytic instruction executable by the processor are further stored, and wherein
the second receiving instruction is configured to instruct receiving an installation request for a second installation package;
the second downloading instruction is configured to instruct downloading the second installation package after the installation request for the second installation package is received according to the second receiving instruction; and
the second analytic instruction is configured to instruct analyzing the second installation package to install an additional function corresponding to the second installation package.

7. The terminal of claim 5, wherein on the memory, a display instruction executable by the processor is further stored, and
the display instruction is configured to instruct displaying a guidance interface to guide a user to selectively install the at least one second installation package, and for a second installation package, displaying a corresponding visualized icon on the guidance interface.

8. The terminal of claim 6, wherein on the memory, a display instruction executable by the processor is further stored, and
the display instruction is configured to instruct displaying a guidance interface to guide a user to selectively install the at least one second installation package, and for a second installation package, displaying a corresponding visualized icon on the guidance interface.

9. A computer readable storage medium, on which is stored a computer program configured to:
receive a simplified installation request for software;
download a first installation package which contains a basic function of the software after the simplified installation request for the software is received according to the first receiving instruction; the software including the first installation package and at least one second installation package which is to be installed selectively and contains an additional function expanded from the basic function of the software; and
analyze the first installation package to install the basic function of the software.

10. The computer readable storage medium of claim 9, wherein the computer program is further configured to:
receive an installation request for a second installation package;
download the second installation package; and
analyze the second installation package to install an additional function corresponding to the second installation package.

11. The computer readable storage medium of claim 9, wherein the computer program is further configured to:
display a guidance interface to guide a user to selectively install the at least one second installation package, and for a second installation package, display a corresponding visualized icon on the guidance interface.

12. The computer readable storage medium of claim 10, wherein the computer program is further configured to:
display a guidance interface to guide a user to selectively install the at least one second installation package, and for a second installation package, display a corresponding visualized icon on the guidance interface.
